(19) United States
(12) Patent Application Publication
(10) Pub. No.: US 2014/0061224 A1
(43) Pub. Date: Mar. 6, 2014

(54) AUTOMATIC VENDING MACHINE

(71) Applicants: HONG FU JIN PRECISION INDUSTRY (WuHan) CO., LTD., Wuhan City (CN); HON HAI PRECISION INDUSTRY CO., LTD., Tu-Cheng (TW)

(72) Inventors: YUN-LUNG CHEN, Tu-Cheng (TW); CHUNG CHAI, Tu-Cheng (TW); DA-LONG SUN, Wuhan City (CN); WEI-YONG MA, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/627,015

(22) Filed: Sep. 26, 2012

(30) Foreign Application Priority Data
Aug. 30, 2012 (CN) 201210314699X

(51) Int. Cl. G07F 11/24

(52) U.S. Cl. 221/277

(57) ABSTRACT

An automatic vending machine includes a base, a support rail, and a locking member. The base defines a mounting hole. The support rail includes a support plate, a positioning piece and a mounting assembly extending from two opposite ends of the support plate. The locking member is secured to the base. The support plate is adapted for placing merchandise. The positioning piece defines a positioning slot. The mounting assembly is supported by the base and includes an elastically deformable resilient piece and a protrusion protruding from the elastically deformable resilient piece. The protrusion is engaged in the mounting hole. The locking member is engaged in the positioning slot.

### BACKGROUND

1. Technical Field

The present disclosure relates to automatic vending machines, and particularly to an automatic vending machine with a merchandise support rail.

2. Description of Related Art

In automatic vending machines, a number of merchandise are placed on a support rail, and the support rail guides the number of merchandise to move out. However, the support rail is generally secured with screws, which is laborious and time consuming to assembly or disassemble. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of an automatic vending machine.

FIG. 2 shows an isometric view of a support rail of the automatic vending machine of FIG. 1.

FIG. 3 is an assembled, isometric view of the automatic vending machine of FIG. 1.

FIG. 4 is an enlarged view of a circled portion IV of the automatic vending machine of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

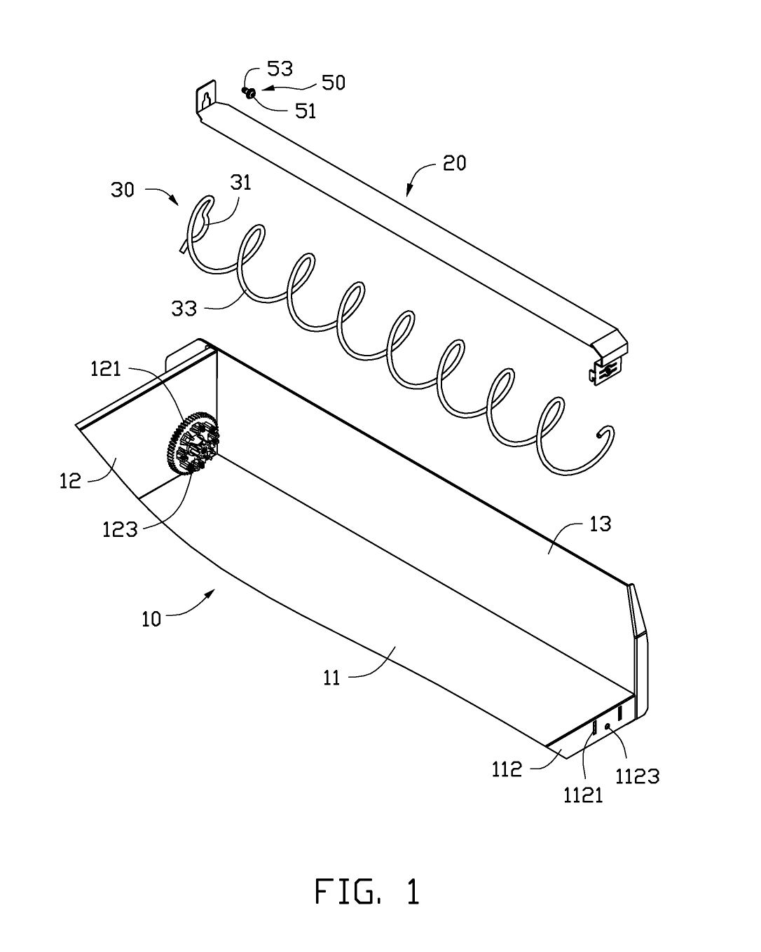

Referring to FIG. 1, an automatic vending machine in accordance with an embodiment is shown. The automatic vending machine comprises a base 10, a support rail 20, and a pushing member 30.

The base 10 comprises a bottom plate 11, two side plates 12 (only one of the two side plates 12 shown in FIG. 1), and a front plate 13. In one embodiment, the bottom plate 11 is substantially perpendicular to each of the two side plates 12 and the front plate 13, and each of the two side plates 12 is substantially perpendicular to the front plate 13.

The bottom plate 11 comprises a sidewall 112 substantially parallel to each of the two side plates 12. The sidewall 112 defines two latching slots 1121 and a mounting hole 1123. In one embodiment, an extending direction of each of the two latching slots 1121 is substantially parallel to each other and perpendicular to the bottom plate 11. The mounting hole 1123 is located between the two latching slots 1121. A rotating pad 121 and a mounting member 123 are secured to each of the two side plates 12. The rotating pad 121 is capable of securing the pushing member 30. The rotating pad 121 connects to a motor (not shown) and is rotatable relative to each of the two side plates 12 by the motor.

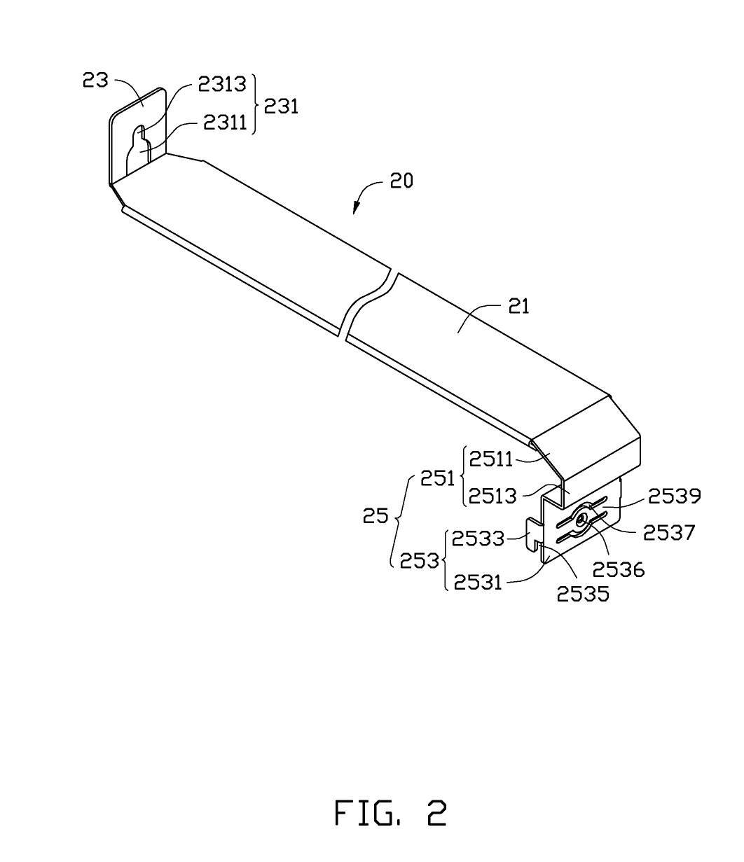

Referring to FIG. 2, the support rail 20 in the embodiment is shown. The support rail 20 comprises a support plate 21, a positioning piece 23, and a mounting assembly 25. The positioning piece 23 and the mounting assembly 25 extend from two opposite ends of the support plate 21. The mounting assembly 25 is elastically deformable.

The positioning piece 23 is substantially perpendicular to the support plate 21 and defines a positioning slot 231. The positioning slot 231 comprises an inserting portion 2311 and a latching portion 2313 communicating with the inserting portion 2311.

The mounting assembly 25 comprises a resilient portion 251 and a mounting portion 253 connected to the resilient portion 251. The resilient portion 251 comprises a connecting piece 2511 and a flange 2513. The connecting piece 2511 extends obliquely from the support plate 21. The flange 2513 connects the connecting piece 2511 and the mounting portion 253. In one embodiment, the flange 2513 is substantially “L” shaped. The mounting portion 253 comprises a mounting piece 2531 and two latching pieces 2533. The two latching pieces 2533 extend from two opposite edges of the mounting piece 2531. In one embodiment, the mounting piece 2531 is substantially parallel to the positioning piece 23, the two latching pieces 2533 are substantially perpendicular to the mounting piece 2531. Each of the two latching piece 2533 defines a cutout 2535. The cutout 2535 extends to the mounting piece 2531. The mounting piece 2531 comprises a resilient piece 2539 and defines two slots 2537 located on two opposite sides of the resilient piece 2539, so that the resilient piece 2539 is elastically deformable. A protrusion 2536 protrudes from the resilient piece 2539 towards the positioning piece 23. A middle part of each of the two slots 2537 is arcuate.

The pushing member 30 comprises a mounting end 31 and a pushing portion 33 connected to the mounting end 31. The pushing portion 33 is for placing goods and capable of pushing the goods out when rotated.

The automatic vending machine further comprises a locking member 50. The locking member comprises a head portion 51 and a locking portion 53 connected to the head portion 51. Apart of the locking portion 53 comprises a plurality of external threads. In one embodiment, a cross-section of the locking member 50 is circular. A diameter of the head portion 51 is greater than a diameter of the locking portion 53 and a width of the inserting portion 2311. The diameter of the locking portion 53 is substantially equal to a width of the latching portion 2313.

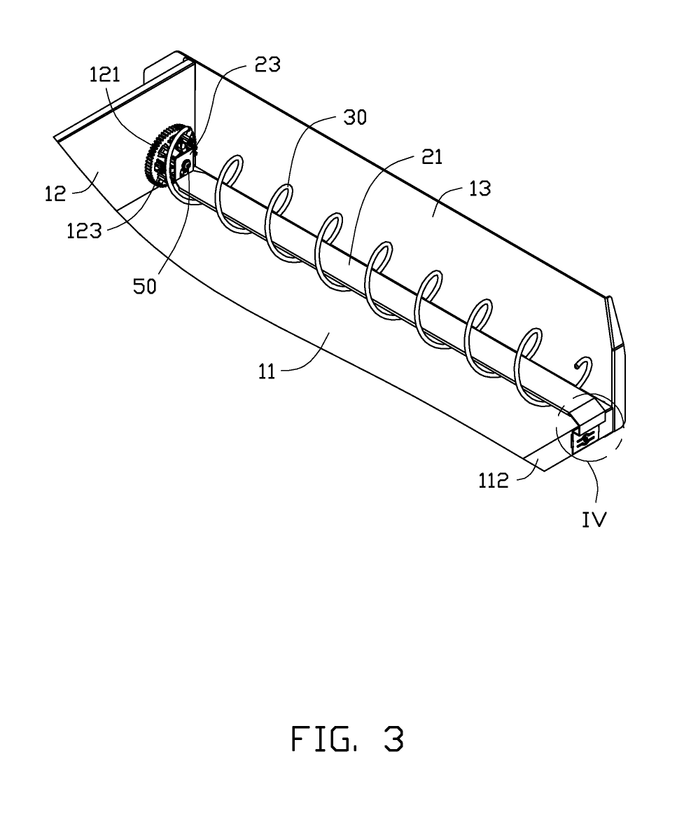

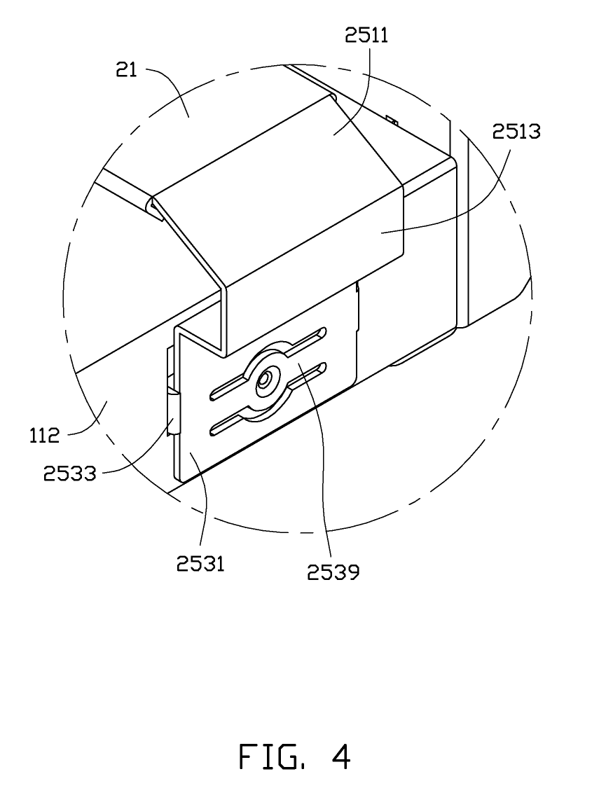

FIG. 3 and FIG. 4 show that, in assembly, a part of the locking portion 53 is screwed in the mounting member 123. The mounting end 31 is secured to the rotating pad 121. The support rail 20 is moved along a first direction, towards each of the two side plates 12, through the pushing portion 33, until the head portion 51 pass through the inserting portion 2311. In this position, the two latching pieces 2533 are inserted into the two latching slots 1121. The protrusion 2536 abuts the sidewall 112 and elastically deforms the resilient piece 2539. The protrusion 2536 is located above the mounting hole 1123. The support rail 20 is moved along a second direction, towards the bottom plate 11, until the protrusion 2536 is aligned with the mounting hole 1123. The resilient piece 2539 restores to engage the protrusion 2536 in the mounting hole 1123. In this position, the locking portion 53 is engaged in the latching portion 2313. The sidewall 112 is engaged in the cutout 2535. Thus, the support rail 20 is secured to the base 10. The first direction is substantially perpendicular to the second direction.

In disassembly, the support rail 20 is moved upwards. The locking portion 53 is disengaged from the latching portion 2313 to the inserting portion 2311. The resilient piece 2539 is elastically deformed outwards to disengage the protrusion 2536 from the mounting hole 1123. The sidewall 112 is disengaged from the cutout 2535. The support rail 20 is moved away from each of the two side plates 12, and then the support rail 20 can be removed from the base 10.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. An automatic vending machine, comprising:
a base defining a mounting hole;
a support rail comprising a support plate, a positioning piece and a mounting assembly extending from two opposite ends of the support plate; and
a locking member secured to the base;
wherein the support plate is adapted for supporting merchandise; the positioning piece defines a positioning slot; the mounting assembly is supported by the base and comprises an elastically deformable resilient piece and a protrusion protruding from the elastically deformable resilient piece; the protrusion is engaged in the mounting hole; and the locking member is engaged in the positioning slot.

2. The automatic vending machine of claim 1, wherein the mounting assembly defines two slots located on two opposite sides of the elastically deformable resilient piece, and a middle part of each of the two slots is arcuate.

3. The automatic vending machine of claim 2, wherein the base comprises a bottom plate and a side plate substantially perpendicular to the bottom plate; the bottom plate comprises a sidewall substantially parallel to the side plate; the base further comprises a mounting member secured to the side plate; the locking member comprises a head portion and a locking portion connected to the head portion; the locking portion is secured to the mounting member and engaged in the positioning slot, and the mounting hole is defined in the sidewall.

4. The automatic vending machine of claim 3, wherein the positioning slot comprises an inserting portion and a latching portion communicating with the inserting portion; a cross-section of each of the head portion and the locking portion is circular, a diameter of the head portion is greater than a diameter of the locking portion, the diameter of the head portion is smaller than a width of the inserting portion, and the diameter of the locking portion is substantially equal to a width of the latching portion.

5. The automatic vending machine of claim 3, wherein the sidewall defines two latching slots; the mounting assembly further comprises a mounting piece and two latching pieces extending from the mounting piece; the mounting piece abuts against the sidewall; the two slots are defined in the mounting piece; and each of the two latching pieces is engaged in each of the two latching slots.

6. The automatic vending machine of claim 5, wherein each of the two latching pieces defines a cutout adjacent to the mounting piece, and the sidewall is engaged in the cutout.

7. The automatic vending machine of claim 5, wherein each of the two latching pieces is substantially perpendicular to the mounting piece.

8. The automatic vending machine of claim 5, wherein an extending direction of each of the two latching slots is substantially perpendicular to the bottom plate.

9. The automatic vending machine of claim 5, wherein the mounting piece is substantially parallel to the positioning piece, and the mounting piece and the positioning piece are substantially perpendicular to the support plate.

10. The automatic vending machine of claim 5, wherein the mounting hole is located between the two latching slots.

11. An automatic vending machine, comprising:
a base comprising a bottom plate and a side plate, the bottom plate comprising a sidewall opposite to the side plate, and the sidewall defining at least one latching slot;
a support rail comprising a support plate, a positioning piece and a mounting assembly extending from two opposite ends of the support plate; and
a locking member secured to the side plate;
wherein the support plate is adapted for supporting merchandise; the positioning piece defines a positioning slot; the mounting assembly comprises a mounting piece and at least one latching piece extending from the mounting piece, the at least one latching piece is engaged in the at least one latching slot; and the locking member is engaged in the positioning slot.

12. The automatic vending machine of claim 11, wherein the mounting piece comprising an elastically deformable resilient piece and a protrusion protruding from the elastically deformable resilient piece; the sidewall further defines a mounting hole; and the protrusion is engaged in the mounting hole.

13. The automatic vending machine of claim 12, wherein the mounting piece defines two slots located on two opposite sides of the elastically deformable resilient piece, and a middle part of each of the two slots is arcuate.

14. The automatic vending machine of claim 12, wherein the at least one latching slot comprises two latching slots, the at least one latching piece comprises two latching pieces, and each of two latching pieces is engaged in each of the two latching slots; and the mounting hole is located between the two latching slots.

15. The automatic vending machine of claim 11, wherein the side plate is substantially perpendicular to the bottom plate; the sidewall is substantially parallel to the side plate; the base further comprises a mounting member secured to the side plate; the locking member comprises a head portion and a locking portion connected to the head portion; and the locking portion is secured to the mounting member and engaged in the positioning slot.

16. The automatic vending machine of claim 15, wherein the positioning slot comprises an inserting portion and a latching portion communicating with the inserting portion; a cross-section of each of the head portion and the locking portion is circular, a diameter of the head portion is greater than a diameter of the locking portion, the diameter of the head portion is smaller than a width of the inserting portion, and the diameter of the locking portion is substantially equal to a width of the latching portion.

17. The automatic vending machine of claim 11, wherein the latching piece defines a cutout extending to the mounting piece, and the sidewall is engaged in the cutout.

18. The automatic vending machine of claim 11, wherein the latching piece is substantially perpendicular to the mounting piece.

19. The automatic vending machine of claim 11, wherein an extending direction of the latching slot is substantially perpendicular to the bottom plate.

20. The automatic vending machine of claim 11, wherein the mounting piece is substantially parallel to the positioning piece, and the mounting piece and the positioning piece are substantially perpendicular to the support plate.
